(19) United States
(12) Patent Application Publication
(10) Pub. No.: US 2014/0062867 A1
(43) Pub. Date: Mar. 6, 2014

(54) Electrode Blinking Device

(71) Applicant: Michael Baumgartner, Winter Park, FL (US)

(72) Inventor: Michael Baumgartner, Winter Park, FL (US)

(21) Appl. No.: 14/017,697

(22) Filed: Sep. 4, 2013

Related U.S. Application Data
(60) Provisional application No. 61/697,531, filed on Sep. 6, 2012.

(51) Int. Cl. G06F 3/01

(52) U.S. Cl. CPC G06F 3/013
USPC 345/156

(57) ABSTRACT

An eyelid movement detector and communication system includes a first eyelid movement sensor for placement near a first eyelid of a first eye, and a second eyelid movement sensor for placement near a second eyelid of a second eye of a subject, wherein the first and second eyelid movement sensors detect movement of the first and second eyelids, respectively, and produce a first eyelid movement signal and a second eyelid movement signal in response to the movement detected. The system further includes a reference sensor located on the subject, and an amplifier for amplifying the eyelid movement signals of the first and second eyelids, wherein the signals are directed to a computer wherein the signals are processed and as a result, a function of the system may be activated.

### CROSS REFERENCE TO RELATED APPLICATIONS

This application claims priority to Provisional Application No. 61/697,531 filed on Sep. 6, 2012.

### BACKGROUND

Systems and devices have been developed to monitor eye or head movement of a user. However, most of these devices are used in order to ensure alertness of a user, for example, during operating a motor vehicle. Sometimes electrodes are provided to monitor the movement of eyelid activity wherein a decrease in eyelid movement has been correlated with drowsiness and tiredness of a subject. Various monitors and alertness systems have been devised to alert a user when their eyelid movement decreases substantially, or when their head begins to fall forward as a result of becoming tired while operating a motor vehicle. These types of devices are used for safety concerns and for the protection of the general public as well as the user. However, these devices do not include the ability to differentiate between different types of eye movement, nor do they allow for communication or operation of various operations or functions of a system controlled by voluntary eyelid movement.

### BRIEF DESCRIPTION OF THE DRAWINGS

FIG. 1 provides a schematic of the basic components of the system.

FIG. 2 provides an illustration of an embodiment of a user interface of the system.

FIG. 3 provides a diagram illustrating an embodiment of a method of communicating with the use of an eyelid movement detector and communication system.

FIG. 4 provides a diagram illustrating the signal generation by the sensors and the function of the system.

### DETAILED DESCRIPTION

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained.

The system described herein provides the ability of a user to communicate and control various functions typically controlled with the user's hands, by using his or her own eyelid(s) to communicate. Hands-free control of certain functions provides many benefits to users of the system discovered herein.

The use of voluntary eyelid movement to conduct various activities is beneficial in many instances. Where a person loses use of their limbs in cases including amputees, those suffering with nervous system disorders such as Amyotrophic Lateral Sclerosis (ALS) or other genetic diseases which affect a person's ability to move their arms, legs, and other parts of their body as in ALS, one's nerve cells die such that messages are no longer sent from the brain to the muscles, therefore the muscles eventually atrophy. Other diseases such as Parkinson's disease, multiple sclerosis, other neurological disorders, strokes, and/or paralysis due to trauma or other causes can also result in an inability to move one's arms or legs. These types of conditions often make it difficult for those suffering from them to accomplish day-to-day tasks.

The subject invention monitors eyelid movement activity. Detection of the movement of a persons' eyelids is used herein to determine whether a person is moving one eyelid at a time (i.e. winking) or moving both eyelids simultaneously (i.e. blinking) or not moving either eyelid (i.e. keeping both eyes open). Therefore, using the ability of a subject to move one eyelid at a time to initiate functions of a system, one must be able to differentiate between a wink and a blinking movement. However, in order to do so, in one embodiment the movement of the eyelids must be first recorded and then transmitted to a computer such that a program can make calculations based on the eyelid movement and translate the eyelid movement into a signal to control functions of the system. As a result, as recognized and developed for the first time herein, an electrode or motion detecting sensor may placed on a subject's skin above or near each eye to record and transmit a signal made by the movement of each eye independently, for example. Eyelid movement activity can be detected electrically by positioning an electrode just above the eyebrow, in a non-limiting example, of an individual in the vicinity of the orbicularis oculi muscle which surrounds the eye. Eyelid movement or blinking by contraction of this muscle produces a small electrical signal which is sensed by the electrode. By positioning a similar reference electrode on an ear or any other portion of the head (e.g. forehead) of the subject away from the orbicularis oculi muscle such that it does not register movement of the orbicularis oculi muscle, an electrical reference signal level can be obtained which is useful in discriminating against false signals such as noise. Both the reference sensor electrode and the eyelid movement electrode will pick up spurious and unwanted background noise, and by using output of the reference electrode sensor as a reference level for the eyelid movement electrode, eyelid movement activity is detected when a voltage is present at the reference electrode. With the use of an amplifier, a strong eyelid movement detection signal with minimal noise interference can be obtained.

Once the signal is detected by the eyelid movement electrode or sensor which is in contact with the skin and produces a current in response to muscle movement, the signal is transmitted to the amplifier which amplifies the signal before its transmission to a computer. The computer or operating system calculates whether the subject has moved one eyelid without the other or whether both eyelids moved simultaneously, or alternatively, whether neither eyelid moved. The computer or operating system takes a signal received from a first electrode placed near a first eyelid of a subject and a signal received from a second electrode placed near a second eyelid of a subject. As a result of the signals received by the computer, a function of the system may be activated in response to one or both of the first and second eyelid movement signals. A comparing function of the computer may compare a first eyelid movement detection signal to a second eyelid movement detection signal of the subject, in a non-limiting example. The comparing function serves to differentiate between a wink and a blink of the subject, wherein a wink occurs when one eyelid of the subject is more closed than the other eyelid at a certain time (i.e. the signal from the winking eye is greater than the signal from the non-winking eye), and a blink occurs when both eyelids of the subject close simultaneously (i.e., both signals may pass a certain threshold level). The computer may additionally receive signals from the closing of both eyelids within a predetermined time period or from a pause in the movement of both eyelids for a predetermined time period, wherein an operation of the system may thereafter be activated as a result.

The eyelid movement detection signals obtained are either subtracted from one another or added together, in one embodiment, to determine whether the eyelid movement was of one eyelid (a wink) or simultaneously both eyelids (a blink) or no movement of either eyelid (both eyelids closed or both eyelids open).

Various formulas are used to determine the movement of the eyelids, some examples are provided herein. Oftentimes when a subject winks with one eye, the other eyelid slightly closes, therefore, the system provided herein can detect which eyelid moved the largest amount to determine which eye was winking and which eyelid was only partially closing as an involuntary response to the winking eye. Therefore, where the second eyelid movement signal is subtracted from the first eyelid movement signal and the result is greater than zero, it is determined that a wink has occurred in the first eye (i.e., a greater amount of movement in the first eyelid and therefore a greater signal received by the electrode near the first eyelid), and a function of the system controlled by the first eyelid movement signal is activated. If the result is less than zero, it is determined that a wink has occurred in the second eye (i.e., a greater amount of movement occurred in the second eyelid or greater signal received by the electrode near the second eyelid), and a function of the system controlled by the second eyelid movement signal is activated. If by subtracting the first eyelid movement signal from the second eyelid movement signal, or vice versa, the result is zero, no functions of the system may be activated, in an embodiment, as the system will determine that either a blink is occurring or that the subjects' eyelids are not moving (i.e., both eyes are open or both eyes are closed). Alternatively, or in addition to these sample calculations, the first eyelid movement signal and the second eyelid movement signal can be added together by the system. If the sum of these two signals is greater than a predetermined threshold value, the system will determine that a blink is occurring, and no function of the system will be activated.

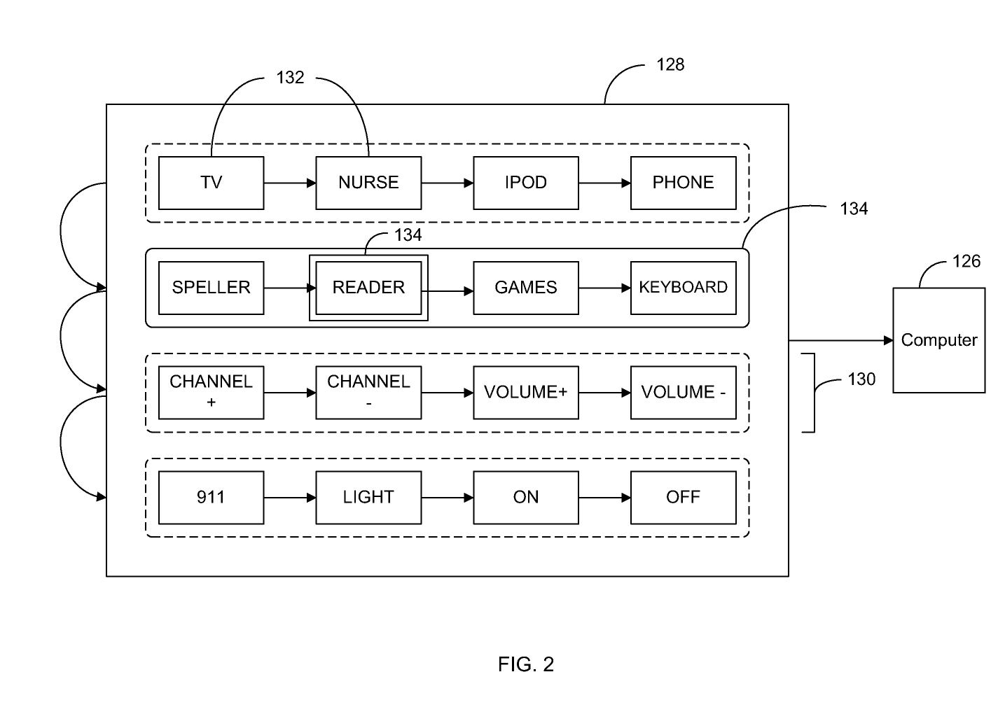

The interface associated with the computer of the device includes a menu of navigation comprising virtual buttons which illuminate in sequential order. Alternatively, each row of the menu of navigation may sequentially illuminate as shown by the dotted lines in FIG. 2 (described in additional detail below). Each virtual button correlates to an operation or a function of the system, such that when the virtual button correlating with the operation or function of the system the user intends to activate is illuminated on the interface, the user can close one eyelid to select the illuminated virtual button to activate the operation of the system associated therewith. Another option would be to sequentially illuminate each row of the interface by winking either one eye or the other eye. As described above, by moving an eyelid to select a virtual button, movement of the orbicularis oculi muscle is recorded as a signal in the electrode nearest the eyelid that is moved. This signal is transferred to an amplifier which is then transferred to a computer, in some instances; the signal may be directly transferred from the electrode to the computer.

In some cases, the winking of one eye or the other eye can provide directional movement or selection of operations of the system. For example, winking with the right eye may serve to increase volume of the system or of a device associated with the system, and winking of the left eye may serve to decrease volume of the system or of a device associated with the system.

System operations may include functions such as powering the system or another associated device on or off, or changing the settings of the system or of another associated device such as a volume or a channel of an audio player, a television, an electronic reader, a phone, etc., for example. The operations may include an interface which resembles a keyboard, for example, allowing a user to type one or more words, make lists, or write an email solely with the use of eyelid movement. The system may further include operations such as a call nurse virtual button or a games virtual button, for example, such that a user can play a game using solely eyelid movement(s). Additional operations of the system may include making a phone call wherein a key pad or a list of contacts is provided on the user interface. Other operations or functions such as spelling words and other such functions may be achieved with the eyelid movement system.

As used herein, the terms “subject”, “user” and “patient” are used interchangeably. As used herein, the term “subject” refers to an animal, preferably a mammal such as a non-primate (e.g., cows, pigs, horses, cats, dogs, rats etc.) and a primate (e.g., monkey and human), and most preferably a human. In some embodiments, the subject refers to a person with limited motor function such as a paraplegic or quadriplegic. In other embodiments, the subject may be an ALS patient whose motor function is deteriorating and has received the eyelid movement detector and communication system prior to the motor impairment reaching a severe level.

The terms “operation” and “function” as used herein can be used interchangeably and include but are not limited to the various tasks of the system that can be accomplished using movement of the eyelids. In some instances an operation of the system is a function that can be controlled by the system. The term “sensors” as used herein includes electrodes and other types of sensors as are known in the art for obtaining and transmitting a signal and/or obtaining or detecting movement such as motion sensors, or accelerometers, in non-limiting examples, and other such types of sensors known to those of skill in the art.

The term “virtual button(s)” as used herein includes any type of virtual input means. The non-limiting examples herein show virtual buttons used as the type of virtual input means; however, the virtual buttons could be replaced with virtual switches or any other type of virtual input means known in the art. In light of the teachings herein, a virtual button includes any visual cue for inputting a selection on an interface, for example.

The term “near” as used herein in regard to the location of the electrode or other sensor in relationship to the eye, orbicularis oculi muscle, eyelid, or surrounding areas includes the electrode or other sensor being on the eyelid or on the subject within a distance from the eyelid in a location where any movement of the eyelid can be obtained, registered or detected by the electrode or sensor. The location of the electrode or sensor includes, but is not limited to, on the eyelid, under the eye, above the eyelid, on the eyebrow, above the eyebrow, or on either side of the eye. The electrode or sensor may be positioned on the skin of the user or patient, in an embodiment, so as to register movement of the eyelid(s).

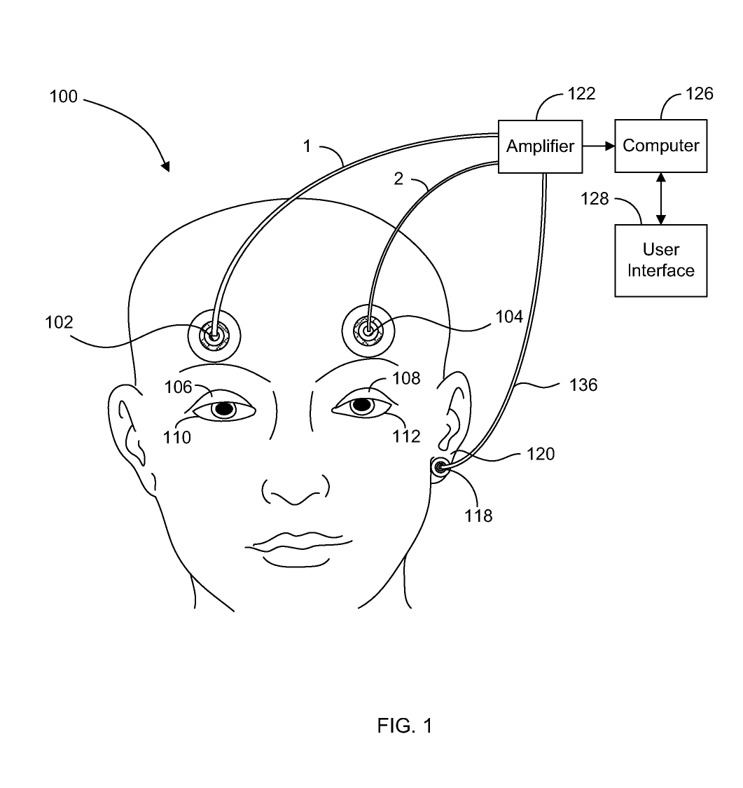

Turning to the Figures, FIG. 1 provides a schematic view of an embodiment of the eyelid movement detector and communication system 100 according the invention herein. The system 100 includes a first eyelid movement sensor 102 for placement near a first eyelid 106 of a first eye 110, and a second eyelid movement sensor 104 for placement near a second eyelid 108 of a second eye 112 of a subject, wherein the first and second eyelid movement sensors 102, 104 detect movement of the first and second eyelids 106, 108, respectively, and produce a first eyelid movement signal 1 and a second eyelid movement signal 2 in response to the movement of the first eyelid 106 and second eyelid 108 detected, respectively. The system 100 further includes a reference sensor 118 located on the subject, wherein the reference sensor 118 can be placed on a portion of the head of the subject, preferably in a location where movement of the orbicularis oculi muscle is not registered by the sensor, for example, on the ear 120. Alternatively, the reference sensor 118 may be placed on the forehead, near the center line of the body, or in another location. The system 100 also includes an amplifier 122, in one embodiment, for amplifying the eyelid movement signals of the first and second eyelids 1, 2, wherein the signals 1, 2, are directed to a computer 126 and wherein the signals 1, 2, are processed to compare the first eyelid movement signal 1 and the second eyelid movement signal 2. Based on the result of the comparison between the two signals 1, 2, a function of the system 100 may be activated. In another embodiment, the comparison function is not required, however, the computer receives signals 1, 2 and a function of the system 100 may be activated in response to one or both of the first and second eyelid movement signals 1, 2. The computer 126 is associated with a user interface 128 which displays various user functions and operations to be activated with the system 100 (example user interface 128 display illustrated in FIG. 2).

Simultaneous (or near simultaneous) movement of both of the first and second eyelids 106, 108 detected by the system 100 fails to activate a function of the system 100, in one embodiment. In another embodiment, near simultaneous or simultaneous movement of both eyelids 106, 108, a number of times (n) within a predetermined time period (T₁) may activate an operation of the system 100. Any value can be assigned to (n), however, in most cases (n) will be 2, 3, 4, 5, or 6. T₁ can be assigned any value as known in the art, however, in most instances, T₁ will be between ½ second and 3 seconds, and in another embodiment T₁ will be between 1-2 seconds. Furthermore, no movement of the first and second eyelids 106, 108 fails to activate a function of the system 100 in another embodiment. In a further embodiment, a pause in movement of the eyelids 106, 108, (i.e., no movement) for a predetermined time period (T₂) can result in activation of an operation of the system 100 including but not limited to powering on or off of the system 100. T₂ may include a similar value range as that of T₁. However, where T₂ pertains to powering on or off of the system, in one embodiment it will include a range of 10-60 minutes or between 20 and 50 minutes, for example.

The system 100 further includes a user interface 128 an example of which is demonstrated for illustration purposes in FIG. 2. The interface 128 is associated with the computer 126, wherein one or more virtual buttons 132 are displayed on the user interface 128 and are illuminated by illumination means 134. Illumination can occur by any means known to one of ordinary skill in the art including but not limited to illumination means such as LED, liquid crystal display, or any other similar means to provide a lit surface from which the virtual buttons 132 may be seen on the user interface 128.

The system 100 is provided in another embodiment, wherein the virtual buttons 132 are illuminated one at a time in sequential order and wherein a virtual button 132 is selected by closing one of either of the first eyelid 106 or the second eyelid 108 when the virtual button 132 to be selected is illuminated. In another embodiment, at least two rows 130 of virtual buttons are displayed on the user interface 128, and each row 130 is illuminated one at a time in sequential order. Each row 130 is selected by closing one of either of the first eyelid 106 or the second eyelid 108 when the row 130 of virtual buttons to be selected is illuminated. The system may also be configured such that closing of both 106, 108 eyelids a predetermined number of times within a predetermined time period controls a function of the system such as powering the system on or off or changing the volume of a device linked to the system, alternatively it may be linked to activation of one of the virtual buttons 132 of the system. Furthermore, a pause in eyelid movement for a predetermined time period may also result in activation of an operation of the system, or powering on or off the system or controlling other such functions.

Furthermore, each row 130 of virtual buttons comprises at least two virtual buttons 132. Once a row 130 is selected (which can be accomplished by winking one eye or the other), each virtual button 132 in the row is illuminated in sequential order. Therefore, a virtual button 132 to be selected in a row 130 of virtual buttons can be selected by closing one of either of the first eyelid 106 or the second eyelid 108 when the row 130 of virtual buttons to be selected is illuminated. Selection of a virtual button 132 by a user activates a corresponding operation of the system 100.

In one embodiment, movement of either of the first eyelid or the second eyelid selects a virtual button in an illuminated row of virtual buttons to be illuminated, wherein movement of the first or second eyelid can provide directional movement of the selection and illumination of each of the virtual buttons.

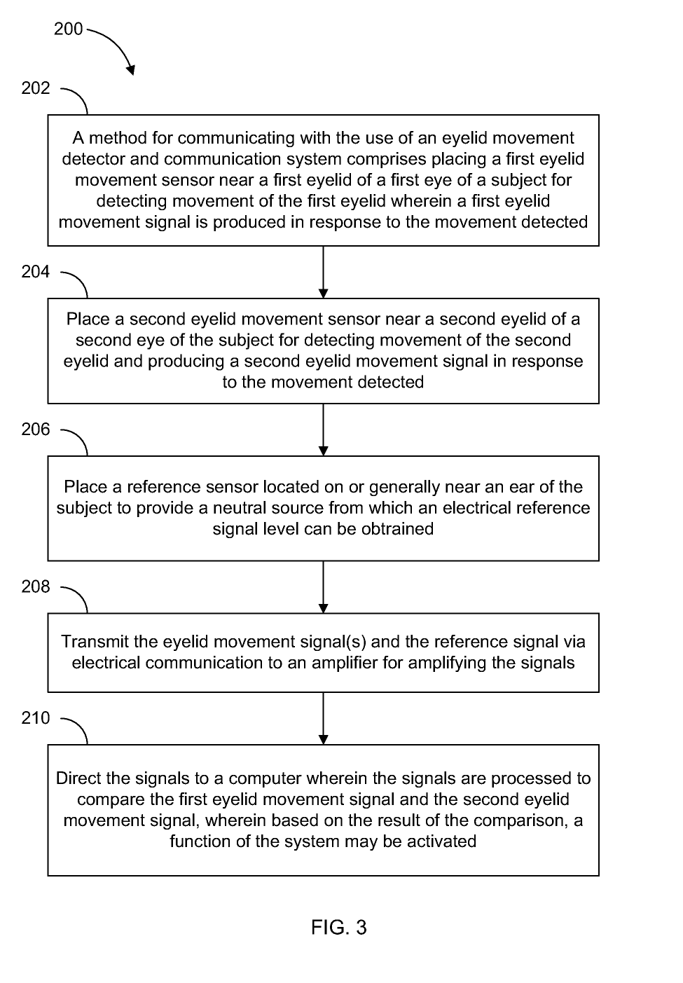

In another embodiment as shown in a diagram of FIG. 3 is a method 200 for communicating with the use of an eyelid movement detector and communication system 100 is provided. The method includes placing 202 a first eyelid movement sensor 102 near a first eyelid 106 of a first eye 110 of a subject for detecting movement of the first eyelid 106 wherein a first eyelid movement signal 1 is produced in response to the movement detected, and placing 204 a second eyelid movement sensor 104 placed near a second eyelid 108 of a second eye 112 of the subject for detecting movement of the second eyelid 108 and producing a second eyelid movement signal 2 in response to the movement detected. The method 200 further includes placing 206 a reference sensor 118 located on or generally near an ear 120 of the subject to provide a neutral source from which an electrical reference signal 136 can be obtained. The method 200 further includes transmitting 208 the eyelid movement signal(s) 1, 2 and the reference signal 136 via electrical communication to an amplifier 122 for amplifying the signals. The method further includes directing 210 the signals 1, 2, 124 to a computer 126 wherein the signals are processed to compare the first eyelid movement signal 1 and the second eyelid movement signal 2, wherein based on the result of the comparison, a function of the system 100 may be activated.

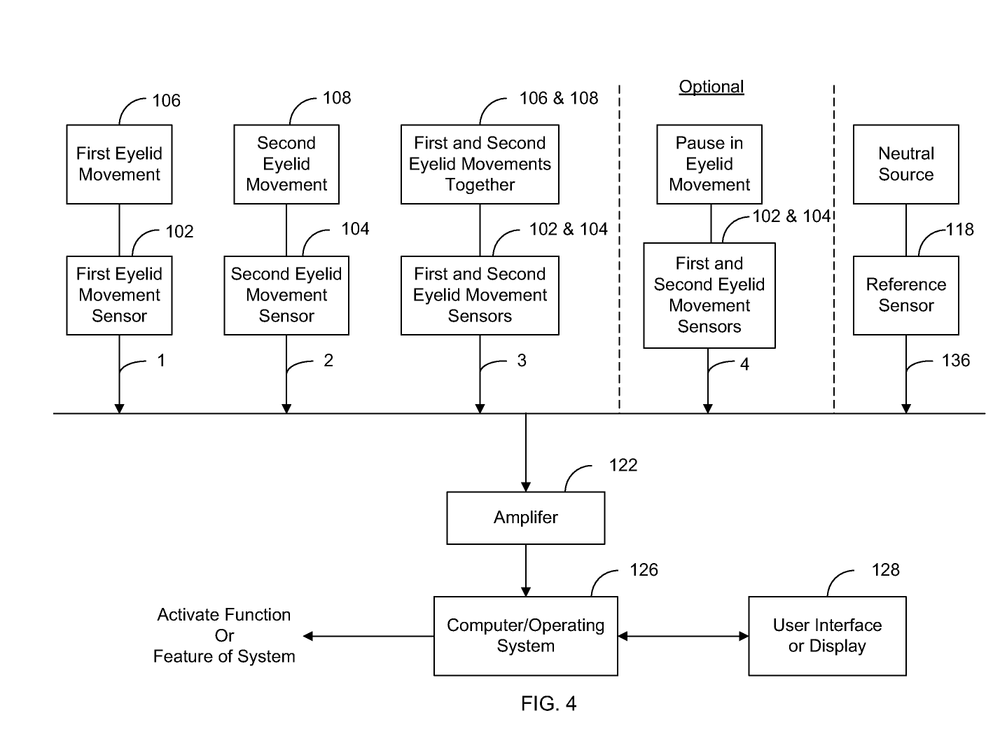

FIG. 4 provides a diagram illustrating an example of signal generation by the first and second eyelid movement sensors 102, 104 as a result of the eyelid activity of the first and second eyes 110, 112 of the subject and the signals generated by each 1, 2 according to an embodiment of the system herein. The computer/operating system 126 is in association with a user interface or display 128, such that functions or operations displayed on the user interface or display 128 can be activated by the computer/operating system 126 as selected by the user of the system 100. While FIG. 4 provides an amplifier 122, the system 100 may be used without the amplifier 22.

Various algorithms or conditions which may be used by the system 100 to determine activation of various operations of the system 100 are provided below. The algorithms or conditions are not intended to be limiting, but are only examples of certain embodiments which may be included as part of the system 100 herein. For example where as registered by the computer or operating system 126, signal 1 is greater than signal 2, an operation associated with signal 1 will be activated, and vice versa. Additionally, the system 100 can be such that an operation associated with signal 3 (which correlates to the movement of both the first and the second eyelids together) can be activated if the first and second eyelids 106, 108 move together a predetermined number of times, denoted “n” during a pre-set period of time, denoted “T₁”. Therefore, for example, where n=2, and T₁= 1/10 second or ½ second, if both eyes are blinked twice within one tenth of a second, the first and second eyelid movement sensors will pick up the movement by both eyes and generate a signal, signal 3. Thereafter, a particular operation of the system 100 which correlates with signal 3 will be activated by the computer or operating system 126.

An optional operation exists where no movement of either eyelid (i.e., a pause in eyelid movement whether both eyes are open or closed) for a predetermined period of time results in activation of an operation of the system 100. For example, no recorded eyelid movement for “T₂” (a second predetermined time period) wherein the time period is 10 minutes, for example, may result in powering on or off of the system 100 if a user of the system 100 fails to move his or her first and second eyelids 106, 108 during the 10 minute time period.

Some of the conditions used to activate the system 100 or control a function thereof are included below:

$$Signal 1 > Signal 2 = activate an operation associated with Signal 1$$

$$Signal 2 > Signal 1 = activate an operation associated with Signal 2$$

$$\frac{Signal 3 ( n )}{{T}_{1}} = activate an operation associated with signal 3 , \\ where n = 2 , 3 , 4 , 5 …$$

$${T}_{1} = 1 / 10 second - 3 seconds$$

$$Signal 4 = \frac{no movement sensed}{{T}_{2}} = power off / sleep mode$$

$${T}_{2} = predeter m ined time period ( e . g . , 10 min , 30 min ) .$$

Another embodiment of the invention provides a method for communication using an eyelid movement detector and communication system, including obtaining a first eyelid movement signal 1 from a first eyelid movement sensor 102 placed near a first eyelid 106 of a first eye 110 of a subject and obtaining a second eyelid movement signal 2 from a second eyelid movement sensor 104 placed near a second eyelid 108 of a second eye 112 of a subject. The method further includes obtaining a reference signal 136 from a reference sensor 118 located on the subject at a neutral source 120 from which an electrical reference signal level can be obtained, and comparing the first eyelid movement signal 1 and the second eyelid movement signal 2, wherein based on the result of the comparison, a function of the system 100 may be activated. The neutral source 120 may be any portion of the subject which can act as a reference, and where movement of the orbicularis oculi muscle will not be detected. This includes, for example, a portion of the forehead, the ear, or any other portion of the head of the subject.

As will be appreciated by one of skill in the art, embodiments of the present invention may be embodied as a device or system comprising a processing module, and/or computer program product comprising at least one program code module. Accordingly, the present invention may take the form of an entirely hardware embodiment or an embodiment combining software and hardware aspects. Furthermore, the present invention may include a computer program product on a computer-usable storage medium having computer-usable program code means embodied in the medium. Any suitable computer readable medium may be utilized including hard disks, CD-ROMs, DVDs, optical storage devices, or magnetic storage devices.

The term processing module may include a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The processing module may have operationally coupled thereto, or integrated therewith, a memory device. The memory device may be a single memory device or a plurality of memory devices. Such a memory device may be a read-only memory, random access memory, volatile memory, non-volatile memory, static memory, dynamic memory, flash memory, and/or any device that stores digital information. A computer, as used herein, is a device that comprises at least one processing module, and optionally at least one memory device.

The computer-usable or computer-readable medium may be or include, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM), a CD ROM, a DVD (digital video disk), or other electronic storage medium. Note that the computer-usable or computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Certain embodiments of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer-readable program code modules. These program code modules may be provided to a processing module of a general purpose computer, special purpose computer, embedded processor or other programmable data processing apparatus to produce a machine, such that the program code modules, which execute via the processing module of the computer or other programmable data processing apparatus, create means for implementing the functions specified in the flowchart and/or block diagram block or blocks.

These computer program code modules may also be stored in a computer-readable memory that can direct a computer or other programmable data processing apparatus to function in a particular manner, such that the program code modules stored in the computer-readable memory produce an article of manufacture.

The computer program code modules may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While certain embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An eyelid movement detector and communication system, the system comprising:
a first eyelid movement sensor for placement near a first eyelid of a first eye, and a second eyelid movement sensor for placement near a second eyelid of a second eye of a subject, wherein the first and second eyelid movement sensors detect movement of the first and second eyelids, respectively, wherein the sensors produce a first eyelid movement signal and a second eyelid movement signal, respectively, in response to a movement detected;
a reference sensor for placement on the subject, said reference sensor to provide a neutral source from which an electrical reference signal level can be obtained;
wherein the eyelid movement and the electrical reference signals are directed to a computer to process said signals, and wherein a function of the system may be activated in response to one or both of the first eyelid movement and second eyelid movement signals.

2. The eyelid movement detector and communication system of claim 1, wherein simultaneous movement of both the first and second eyelids fails to activate a function of the system.

3. The eyelid movement detector and communication system of claim 1, wherein no movement of the first and second eyelids fails to activate a function of the system.

4. The eyelid movement detector and communication system of claim 1, wherein a user interface is associated with the system, wherein one or more virtual buttons are displayed on the user interface.

5. The eyelid movement detector and communication system of claim 4, wherein the virtual buttons are illuminated, one at a time in sequential order and a virtual button is selected by closing one of either of the first eyelid or the second eyelid when the virtual button to be selected is illuminated.

6. The eyelid movement detector and communication system of claim 4, wherein at least two rows of virtual buttons are displayed on the user interface, and wherein each row is illuminated one at a time in sequential order.

7. The eyelid movement detector and communication system of claim 6, wherein each of two rows is selected by closing one of either of the first eyelid or the second eyelid when the row to be selected is illuminated.

8. The eyelid movement detector and communication system of claim 7, wherein each row comprises at least two virtual buttons, wherein once a row is selected, each virtual button in the row is illuminated in sequential order.

9. The eyelid movement detector and communication system of claim 8, wherein a virtual button to be selected in a row of virtual buttons can be selected by closing one of either of the first eyelid or the second eyelid when the virtual button to be selected is illuminated.

10. The eyelid movement detector and communication system of claim 4, wherein selection of a virtual button activates a corresponding function of the system.

11. The eyelid movement detector and communication system of claim 1, wherein the reference sensor is positioned generally in the middle of the subject's forehead.

12. The eyelid movement detector and communication system of claim 1, wherein the reference sensor is positioned on or near an ear of the subject.

13. The eyelid movement detector and communication system of claim 1, wherein the first and/or second eyelid movement sensors and the reference sensor each comprise an electrode, wherein said electrode is in contact with the skin, and said electrode produces a current in response to a muscle movement.

14. The eyelid movement detector and communication system of claim 1, wherein the reference sensor is positioned on a portion of a head of the subject which does not detect movement of the first or second eyelid.

15. The eyelid movement detector and communication system of claim 1, wherein no movement sensed by the first and second eyelid movement sensors over a predetermined time period results in the generation of a signal, wherein when processed by the computer, activates a function of the system.

16. The eyelid movement detector and communication system of claim 15, wherein the function includes powering the system on and/or off.

17. The eyelid movement detector and communication system of claim 1, wherein movement of both the first and second eyelids a predetermined number of times (n) during a pre-set time period (T₁) results in activation of a function of the system.

18. The eyelid movement detector and communication system of claim 17, wherein the predetermined number of times (n) ranges between 2-5 times.

19. The eyelid movement detector and communication system of claim 17, wherein the predetermined number of times (n) ranges between 3-4 times.

20. The eyelid movement detector and communication system of claim 17, wherein T₁ ranges between one half of a second and 3 seconds.

21. The eyelid movement detector and communication system of claim 17, wherein T₁ ranges between 1-2 seconds.

22. A method for communication using an eyelid movement detector and communication system, the system comprising:
obtaining a first eyelid movement signal from a first eyelid movement sensor placed near a first eyelid of a first eye of a subject;
obtaining a second eyelid movement signal from a second eyelid movement sensor placed near a second eyelid of a second eye of a subject;
obtaining a reference signal from a reference sensor located on the subject at a neutral source from which an electrical reference signal level can be obtained;
processing with a computer the first eyelid movement signal and the second eyelid movement signal, wherein a function of the system is activated in response to one or both of the first and second eyelid movement signals.

23. The method of claim 22, wherein the reference sensor is positioned on a forehead of the subject or on or near an ear of the subject.

24. The method of claim 22, wherein the first and/or second eyelid movement sensor(s) and the reference sensor comprise electrodes, wherein said electrodes are in contact with the skin, and said electrodes produce a current in response to a muscle movement.

25. The method of claim 22, wherein the reference sensor is positioned on a portion of a head of the subject which does not detect movement of the first or second eyelid.

26. The method of claim 22, wherein the first eyelid movement and/or second eyelid movement sensor(s) comprise a motion sensor to detect movement of the first and/or second eyelid(s).

27. The method of claim 22, wherein the reference sensor comprises a motion sensor to detect movement.

28. The method of claim 22, wherein activating the function of the system comprises the selection of a virtual button on a user interface, wherein said selection controls or initiates the function of the system which correlates with the virtual button selected.

29. The method of claim 22, further comprising amplifying with an amplifier the first eyelid movement, second eyelid movement, and/or reference signals, prior to processing of the signals with the computer.

30. The eyelid movement detector and communication system of claim 1, further comprising an amplifier for amplifying the eyelid movement signals of the first and second eyelid movement sensors.

31. The eyelid movement detector and communication system of claim 1, wherein the first and/or second eyelid movement sensors and the reference sensor each comprise a motion sensor, wherein the motion sensor detects movement and produces a signal in response to the movement detected.
